(19) United States
(12) Patent Application Publication
(10) Pub. No.: US 2015/0253989 A1
(43) Pub. Date: Sep. 10, 2015

(54) CARD READER CONTROLLER WITH COMPRESSION ENGINE

(71) Applicant: HANGZHOU DIANZI UNIVERSITY, HANGZHOU CITY (CN)

(72) Inventors: Lingyan Fan, Hangzhou City (CN); Shi Wang, Hangzhou City (CN); Chris Tsu, Saratoga, CA (US)

(73) Assignee: HANGZHOU DIANZI UNIVERSITY, HANGZHOU CITY (CN)

(21) Appl. No.: 14/199,987

(22) Filed: Mar. 6, 2014

(51) Int. Cl. G06F 3/06

(52) U.S. Cl. CPC G06F 3/061; G06F 3/0685; G06F 3/0661

(57) ABSTRACT

A card reader controller engine includes an interface controller responsive to information. The engine is coupled to the interface controller and is configured to compress the information before the information is to be stored in a memory card. A master interface is coupled to the engine and is further responsive to the compressed information for storage in the memory card.

### BACKGROUND

Various embodiment of the invention relate generally to memory cards and particularly to memory card readers.

Memory cards offer portability for transferring and/or maintaining large amounts of data, in various forms, and are therefore widely employed. Examples of information stored in memory cards are video, pictures, data files, and a host of other types of information.

As memory has dropped in price and size, applications employing memory, such as memory card readers, have benefited greatly. A memory card today has a memory capacity orders of magnitude more than those of, for example, five years ago and cost less than an equivalent memory card if it would have been possible to make such memory cards. Memory cards are expected to continue to enjoy these benefits in the future.

Security is a near-must for the protection of information to guard against or at least reduce the risk of information theft. Unfortunately, as is well known, identity theft has been a major concern. Portability of sensitive information, in a memory card, presents at times catastrophic risks.

Further, the transfer of information from a memory card to a host machine, for example from a portable memory drive to a personal computer (PC), currently takes time. Needless to say, this is, at a minimum, inconvenient for users of memory cards. Performance of the memory card is hindered by current controllers that are employed to read saved information transferred from a memory card to a host.

Accordingly, there is a need for card readers with higher performance and security.

### SUMMARY

Briefly, a card reader controller engine includes an interface controller responsive to information. The engine is coupled to the interface controller and is configured to compress the information before the information is to be stored in a memory card. A master interface is coupled to the engine and is further responsive to the compressed information for storage in the memory card.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a card reader controller engine, in accordance with an embodiment of the invention.

FIG. 2 shows a card reader system, in accordance with an embodiment of the invention.

FIG. 3 shows a card reader system, in accordance with another embodiment of the invention.

FIG. 4 shows a card reader system, in accordance with yet another embodiment of the invention.

### DETAILED DESCRIPTION OF EMBODIMENTS

Particular embodiments and methods of the invention disclose a storage device having a disk controller and a non-volatile memory coupled to the disk controller and operable to save one or more passwords. The storage device further includes a media with more than one partition, the disk controller making each partition to be accessible to one or more users based on the saved one or more passwords.

The following description describes a card reader controller. The card reader employs one or more data compression/decompression engines causing improved performance and greater security, as discussed below.

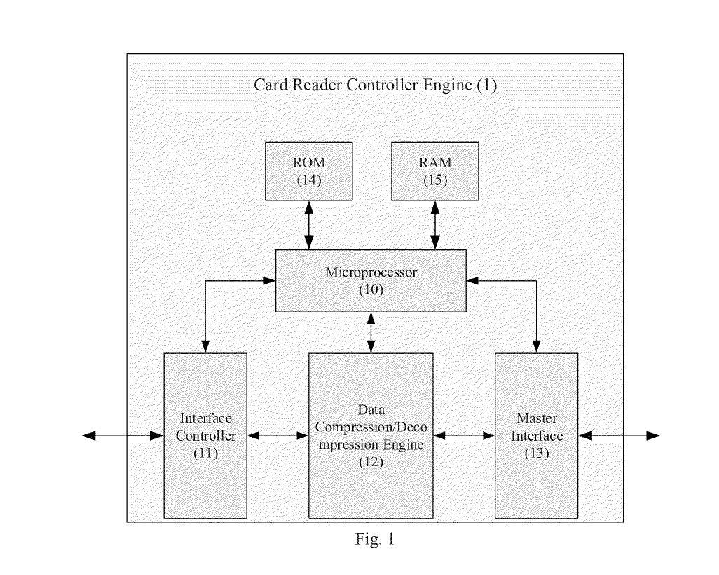

Referring now to FIG. 1, a card reader controller engine 1 is shown to include a microprocessor 10, an interface controller 11, a data compression/decompression engine 12, a master interface 13, a read-only-memory (ROM), and a random access memory (RAM), in accordance with an embodiment of the invention.

The microprocessor 10 is shown coupled to the ROM 14, the RAM 15, the interface controller 11, the data compression/decompression engine 12, and the master interface 13. As such, the microprocessor 10 controls the remaining blocks shown in the card read controller engine 1. The interface controller 11 is typically in communication with a host (not shown). Information, such as data, is transferred between the card reader controller engine 1 and the host through the interface controller 11 and under the direction of the microprocessor 10.

The master interface 13 is typically in communication with storage devices (not shown), such as memory cards. Information, such as data, is transferred between the card reader controller engine 1 and storage device(s) through the master interface 13 and under the direction of the microprocessor 10.

The data compression/decompression engine 12, as its name suggests, decompresses information received by the card reader engine 1 from a host, through the interface controller 11, and information received by the card reader engine 1 from storage device(s), through the master interface 13. The engine 12 similarly compresses information that is to be sent from the card reader engine 1 to storage device(s) through the interface controller 11, under the direction of the microprocessor 10. Further, the engine 12 compresses information received by the card reader controller engine 1 from storage device(s) through the master interface 13 and under the direction of the microprocessor. Accordingly, the data compression/decompression engine 12 is coupled to the interface controller 11 and the master interface 13.

In embodiments of the invention, the host is compliant with, without limitation, Universal Serial Bus (USB), Serial ATA (SATA) or Peripheral Component Interconnect Express (PCIe). The engine 1 resides externally to the host.

The ROM 14 and the RAM 15 are both shown coupled to the microprocessor 10. The ROM 14 is typically used to maintain the program (software/firmware) executed by the microprocessor 10 and the RAM 15 is typically used to maintain data and/or program employed by the microprocessor. The microprocessor 10 operates by executing code (also referred to herein as “program”) residing in the ROM 14 and/or the RAM 15.

The card reader controller 1 is on a single integrated circuit (IC), in an embodiment of the invention. In another embodiment of the invention, it is on multiple ICs and/or printed circuit boards (PCBs). In yet another embodiment of the invention, the card reader controller 1 is on a single PCB. In still other embodiments of the invention, some or all portions of the card reader controller 1, shown in FIG. 1, are implemented in software and/or firmware.

In operation, the card reader controller 1 (also referred to herein as “memory card reader”) receives information through the interface controller 11 and under the direction of the microprocessor 10, data compression/decompression engine 12 decompresses the information as the information has been previously compressed. The decompressed information is then sent to the master interface 13, under the direction of the microprocessor 10, to a storage device, such as but not limited to, a memory card. During transmitting of information from the card controller engine 1, as earlier noted, the information is compressed before it is sent. The information is received either through the interface controller 11 or the master interface 13 and, under the direction of the microprocessor 10, it is sent to the information compression/decompression engine 12, which compresses the information and sends the compressed information to either the interface controller 11 or the master interface 13 depending on the direction of the information flow.

The data compression/decompression engine 12 may use one of many known algorithms to compress/decompress information. Without limitation, examples of compression/decompression algorithms are: Lempel-Ziv-Renau (LZR) and Lempel-Ziv-Welch (LZW).

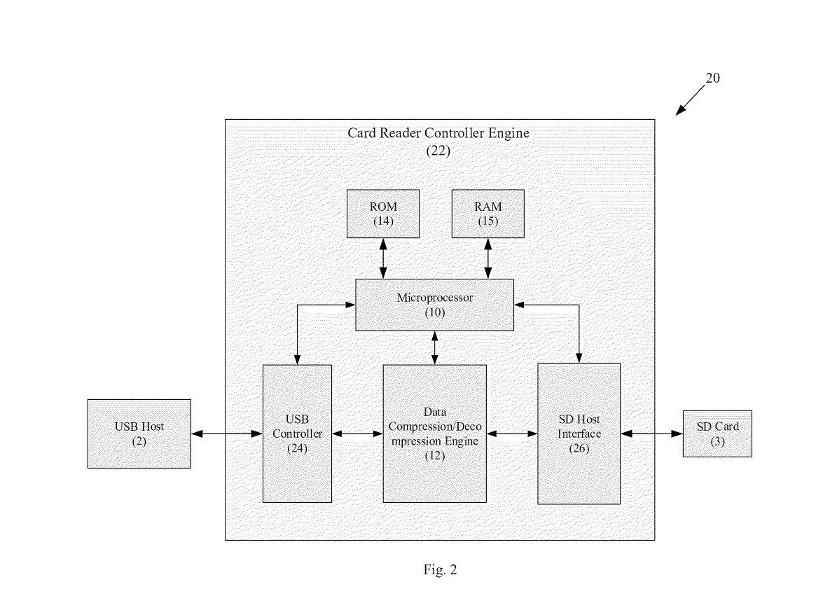

FIG. 2 shows a card reader system 20, in accordance with an embodiment of the invention. The system 20 is shown to include the card reader controller engine 22, the Universal Serial Bus (US) host 2, and the Storage Device (SD) card 3. The engine 22 is shown coupled to the USB host 2 and the SD card 3. The engine 22 is analogous to the engine 1 of the embodiment of FIG. 1 except that the interface controller 11 of the engine 1 is replaced with the USB controller 24 in the engine 22 and the master interface 13 of the engine 1 is replaced with the SD host interface 26 in the engine 22.

In FIG. 2, the USB controller 24 is shown coupled to the USB host 2 and the SD host interface 26 is shown coupled to the SD card 3. In this respect, the engine 22, through the USB controller 24, transmits and receives information to and from the USB host 2 and, through the SD host interface, transmits and receives information to and from the SD card 3. The USB host 2 complies with the USB Standard and the SD card 3 complies with the SD Standard.

In operation, analogous to the engine 1 of the embodiment of FIG. 1, information from the USB controller 24 is transmitted to the data compression/decompression engine 12 and decompressed and then transmitted from the data compression/decompression engine 12 to the SD host interface 26 to be sent to the SD card 3 where it is saved. Similarly, information from the SD card 3 is transmitted to the SD host interface 26 and then sent to the data compression/decompression engine 12 where it is decompressed before it is sent to the USB controller 24 to be transmitted to the USB host 2. When information, received from the SD card 3 is not compressed, upon the SD host interface 26 sending the information to the data compression/decompression engine 12, it is compressed and then sent to the USB host 2, through the USB controller 24. Similarly, when uncompressed (raw) information is received from the USB host 2, it is compressed by the data compression/decompression engine 12 before it is passed on the SD card 3.

The SD card 3 is a portable memory card used to save information and/or transfer information from one device to another. For example, the SD card 3 may maintain backed-up information that is to be retrieved due to a malfunction and therefore corruption of current information. In this respect, the information is saved onto the SD card 3 and when the SD card 3 is connected to the engine 22, the backed-up information is transmitted, through the SD host interface 26, to the data compression/decompression engine 12 assuming it is compressed information. The data compression/decompression engine 12 decompresses the information and transmits the decompressed information to the USB controller 24. The USB controller 24 ultimately transmits the decompressed information to the USB host 2, which can restore the information.

As an example of the improvement of the system of FIG. 2 and those of other embodiments herein, assuming the data transfer rate of SATA to be 250 Mega Bytes (MB)/secon (s) and the transfer rate of SD card is 50 MB/s, with the use of two SD cards connected to the card reader controller engine, the effective transfer rate is 100 MB/s when no data compression is perform. Assuming further that the average data compression ratio is 0.5, then the effective data transfer rate is 100 MB/s÷0.5=200 MB/s (or doubled) when data compression is performed, and the performance accordingly is greatly improved by the card reader controller engines of the various embodiments of the invention.

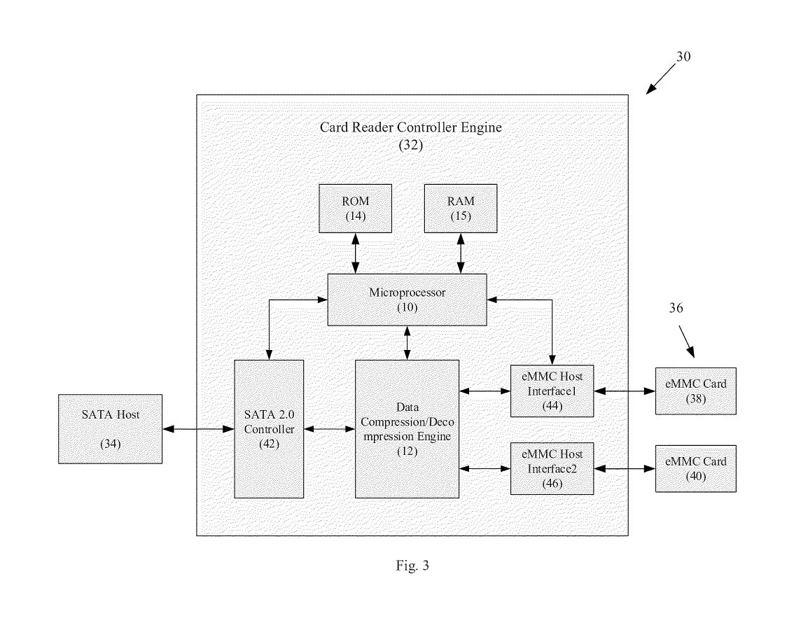

FIG. 3 shows a card reader system 30, in accordance with another embodiment of the invention. The system 30 is shown to include a card reader controller engine 32 coupled to a SATA host 34 and e-Multimedia Card (eMMC) cards 36. In the embodiment of FIG. 3, the eMMC cards 36 is shown to include two eMMC cards, namely eMMC card 38 and eMMC card 40. It is however understood that two eMMC cards is merely being used as an example and that any number of eMMC cards may be employed including a single eMMC card.

The card reader controller engine 32 is analogous to the engine 22 of the embodiment of FIG. 2 except that in place of the USB controller 24, the SATA controller 42 is employed by the engine 32 and in place of the SD host interface 26, one or more eMMC host interfaces 44 and 46 are employed by the engine 32. The number of eMMC host interfaces is the same as the number of eMMC cards employed. An example of the SATA controller 42 is a controller that complies with the SATA Standard 2.0 although other versions of the SATA standard are contemplated.

As in the operation of the system 30 of FIG. 3, the engine 32 sends and receives information to and from the SATA host 34 through the SATA controller 42. The SATA host 34 and the SATA controller 42 both comply with the SATA Standard. The controller 42, under the control of the microprocessor 10, sends information to the data compression/decompression engine 12 for compression or decompression, as the case may be, and the data compression/decompression engine 12 compresses/decompresses the information and passes the same onto the eMMC cards 36 through the eMMC host interfaces 44 and 46. Similarly, the engine receives information from the eMMC cards 36 through the eMMC host interfaces 44 and 46, under the direction of the microprocessor 10. The received information is then compressed or decompressed, as the case may be, by the data compression/decompression engine 12, which passes the compressed/decompressed information to the SATA host 34 through the SATA controller and under the direction of the microprocessor 10.

In embodiments using two eMMC cards, the data compression/decompression engine 12 compresses/decompresses information intended for or received from the eMMC card 38, through the eMMC host interface 44, and then compresses/decompresses information intended for or received from the eMMC card 40.

While not shown in FIG. 2, it is contemplated that the system 20 of FIG. 2 may employ multiple SD cards, as done in the system 30 of FIG. 3 with multiple eMMC cards. In embodiments where multiple SD cards are employed, multiple SD host interfaces need be employed.

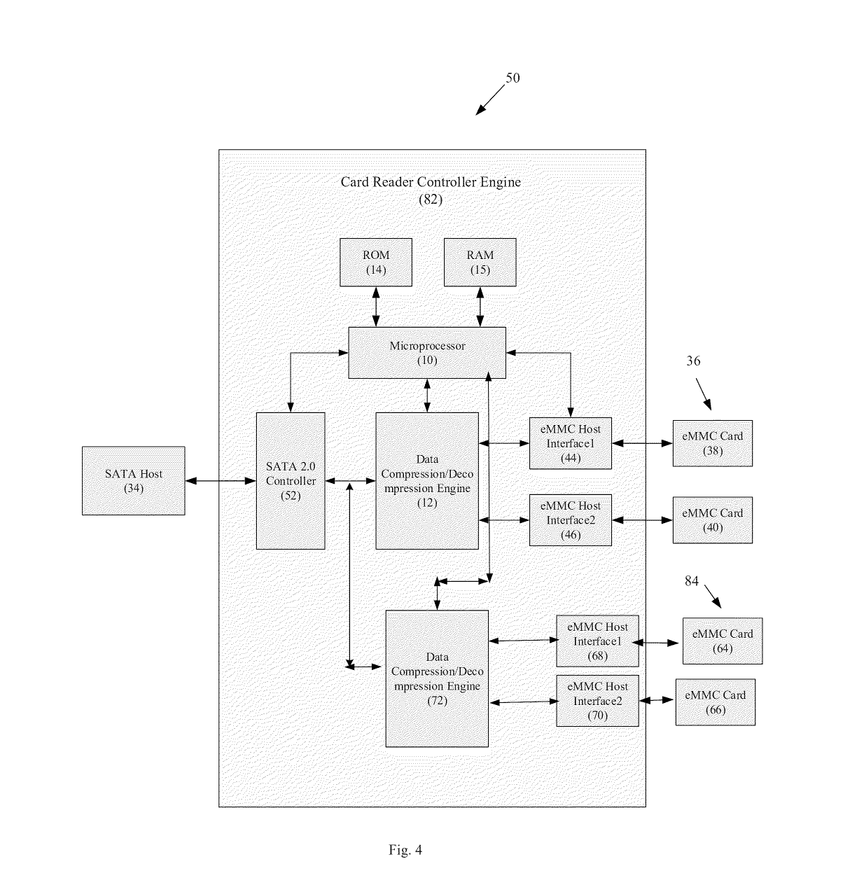

FIG. 4 shows a card reader system 50, in accordance with an embodiment of the invention. The system is analogous to the system 30 of FIG. 3 except that multiple data compression/decompression engines are employed by the system 50 with each data compression/decompression engine coupled to two eMMC host interfaces. For example, while the data compression/decompression engine 12 is shown coupled to the eMMC cards 36, as shown in the embodiment of FIG. 3, a second data compression/decompression engine 72 is shown coupled to two eMMC host interfaces, the eMMC host interface 68 and 70, which are shown coupled to the eMMC cards 84. The eMMC cards 84 is shown to include the eMMC cards 64 and 66. This allows parallel processing by the two data compression/decompression engines. Each of the engines 12 and 72 can perform compression/decompression of information at substantially the same time therefore increasing the performance of the system. This is obviously at the price of having a larger card reader controller engine.

While two eMMC host interfaces are shown coupled to a single data compression/decompression engine, any suitable number of eMMC host interfaces may be coupled to a data compression/decompression engine. Additionally, while two data compression/decompression engines are employed in the system 50, any suitable number of data compression/decompression engines may be employed. Clearly, with the addition of data compression/decompression engines, the performance is increased.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A card reader controller engine comprising:
an interface controller responsive to information;
an engine coupled to the interface controller and configured to compress the information before the information is to be stored in a memory card; and
a master interface coupled to the engine and responsive to the compressed information for storage in the memory card.

2. The card reader controller engine of claim 1, further including a microprocessor, the engine, the interface controller, and the master interface transmitting or receiving the information under the control of the microprocessor.

3. The card reader controller engine of claim 1, wherein the interface controller is in communication with a host to receive the information.

4. The card reader controller engine of claim 3, wherein the host is compliant with one of USB, SATA or PCIe.

5. The card reader controller engine of claim 1, wherein the engine configured to decompress the information.

6. The card reader controller engine of claim 1, wherein the master interface being responsive to another information and transmitting the same to the engine.

7. The card reader controller engine of claim 6, wherein the engine is configured to compress the another information for transmission through the interface controller.

8. The card reader controller engine comprising:
a interface controller responsive to information;
an engine coupled to the interface controller and configured to compress the information before the information is to be transmitted to a host; and
a master interface coupled to the engine responsive to the compressed information.

9. The card reader controller engine of claim 8, further including a microprocessor, the engine, the interface controller, and the master interface transmitting or receiving the information under the control of the microprocessor.

10. The card reader controller engine of claim 8, wherein the interface controller is in communication with a host to which the another information is transmitted.

11. The card reader controller engine of claim 10, wherein the host is compliant with one of USB, SATA and PCIe.

12. The card reader controller engine of claim 8, wherein the engine is configured to decompress the another information.

13. The card reader controller engine of claim 8, wherein the another information being received from a storage device (SD) card.

14. The card reader controller engine of claim 8, wherein the another information being received from a memory card.

15. A card reader system comprising:
a host;
a memory card;
a card reader controller engine coupled to the host and the memory card and including,
an interface controller responsive to information from the host;
an engine coupled to the interface controller and configured to compress the information; and
a master interface coupled to the engine and responsive to the compressed information for storage in the memory card.

16. The card reader system of claim 15, wherein the host is a USB host.

17. The card reader system of claim 15, wherein the interface controller is a USB controller.

18. The card reader system of claim 15, wherein the master interface is a SD host interface.

19. The card reader system of claim 15, wherein the memory card is a SD card.

20. The card reader system of claim 15, further including more than one memory card.

21. The card reader system of claim 15, wherein the memory card is a eMMC card.

22. The card reader system of claim 15, wherein the host is a SATA host.

23. The card reader system of claim 15, wherein the interface controller is a SATA controller.

24. The card read system of claim 15, further including more than one master interface.

25. The card reader system of claim 15, further including more than one engine.

26. The card reader system of claim 15, wherein the engine is coupled to more than one master interface.

27. The card reader system of claim 26, wherein each of the more than one master interfaces is coupled to a distinct memory card.

28. The card reader system of claim 27, wherein each of the more than one memory cards is a eMMC card.

29. The card reader system of claim 15, further including more than one engine, the more than one engines configured to compress substantially simultaneously.

30. The card reader system of claim 29, wherein each of the more than one engine is coupled to more than one master interface.

31. The card reader system of claim 30, wherein the more than one master interfaces is coupled to more than one memory card.

32. The card reader system of claim 15, wherein the host is compliant with one of USB, SATA and PCIe.
